(19) United States
(12) Patent Application Publication
(10) Pub. No.: US 2010/0188939 A1
(43) Pub. Date: Jul. 29, 2010

(54) Multicolored LCD Watch and Clock

(76) Inventor: Chung Wai Tsang, Wong Chuk Hang Hong Kong (CN)

Correspondence Address: JOHN ALEXANDER GALBREATH, 2516 CHESTNUT WOODS CT, REISTERSTOWN, MD, 21136, US

(21) Appl. No.: 12/670,122

(22) PCT Filed: Aug. 14, 2008
(86) PCT No.: PCT/CN08/71987

§ 371 Date: Jan. 22, 2010

(30) Foreign Application Priority Data
Jun. 13, 2008 (CN) 20082011895.5

(51) Int. Cl. G04G 9/06

(52) U.S. Cl. 368/242

(57) ABSTRACT

A multicolored LCD watch/clock, comprising a top shell (1), a bottom shell (2), a drive circuit and a LCD (4) which is located on said top shell (1) and is connected to said drive circuit, characterized in that there is a reflecting module (5) under said LCD (4), wherein multiple reflectors corresponding with said LCD (4) are arranged on said reflecting module (5). The reflectors include illuminable or reflecting polyhedrons made by materials such as diamond, crystal, glass, plastic, metal and their analogs.

### TECHNICAL FIELD

The present patent application relates to a watch and clock, and more particularly to a multicolored LCD watch and clock that combines functions of decorating, illuminating/reflecting and timing.

### BACKGROUND ART

At present, with the progress of technology and the constant improvement of people's material and culture living standards, various kinds of watch and clock are not only necessary commodities for people's daily life, but also decorations used by people. Nowadays, most watch and clock manufacturers pay their attentions to the designs and modifications on shapes and patterns only, but overlook the improvement and innovation on structures. Thus, comparing current watches and clocks with traditional ones, not much material progress has been made. The limitations exist upon the lack of innovation on the structure and the unitary function. Although the market is full of beautiful watches and clocks, but they all adopt unitary illuminating method. For instance, using black color to display the numbers, areas other than numbers is transparent, or, using transparent color to display the numbers and using solid colors for areas other than numbers. However, with the constant growth of people's consumption taste, the competitive strength of the above-mentioned unitary display method is getting weaker and weaker.

### SUMMARY

The present patent application is designed to address the current technology's limitation of the above-mentioned watch and clock's unitary displaying method, providing a multicolored LCD watch and clock that combines the functions of decorating and timing.

According to the present patent application the multicolored LCD watch and clock comprises a top shell, a bottom shell, a drive circuit and a LCD which is located on the said top shell and is connected to the said drive circuit, characterized in that there is a reflecting module under the said LCD, wherein multiple reflectors corresponding with the said LCD are arranged on the said reflecting module.

In the above-mentioned multicolored LCD watch and clock, the said reflector includes reflecting polyhedrons which are made of diamond, crystal, glass, plastic, metal and the like.

In the above-mentioned multicolored LCD watch and clock, a PCB is arranged between the said top shell and the said bottom shell, wherein the said drive circuit locates on the said PCB.

In the above-mentioned multicolored LCD watch and clock, a battery connected to the said drive circuit is arranged on the said PCB.

The multicolored LCD watch and clock of the present patent application can achieve following advantageous effects: by placing materials such as diamond, crystal, glass, plastic, metal and their analogs under the LCD, when the LCD needs to be illuminated and the displaying segments turn to be transparent, these illuminable or reflecting polyhedrons will reflect lights in various colors, thus increase the watch and clock's viewing and admiring performance.

### DESCRIPTION OF DRAWINGS

Further illustration is provided below in the combination of attached figures and actual examples, among the figures:

FIG. 1A is the structural diagram of the multicolored LCD watch/clock;

FIG. 1B is the sectional view of the multicolored LCD watch/clock;

FIG. 2 is the structural diagram of the LCD of the multicolored LCD watch/clock;

FIG. 3 is the structural diagram of the reflecting module of the multicolored LCD watch/clock.

### DETAILED DESCRIPTION

In order to clearly demonstrate the technical problem, technical solution and beneficial effect that the present patent application intends to address, further details of the present patent application are provided below in the combination of figures and examples. It should be noted that the description provided here intends to explain the present patent application, but not limited to the following example.

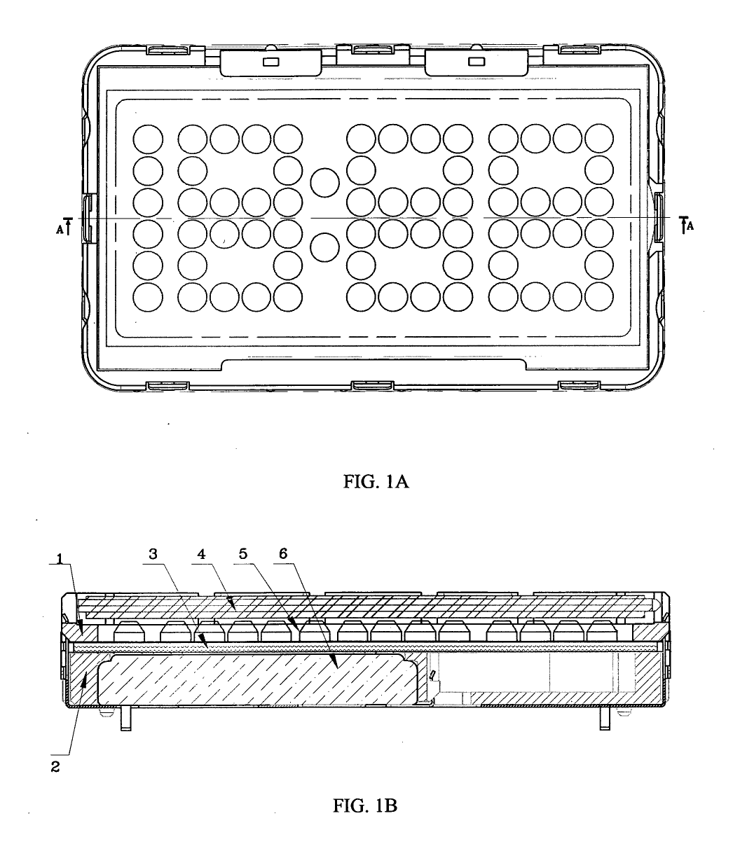

FIG. 1A and 1B show the multicolored LCD watch/clock according to the present patent application. It comprises a top shell 1, a bottom shell 2, a PCB 3 and a LCD 4 which locates on the shell 1, the top shell 1 and the bottom shell 2 is integrated by a clip lock. PCB 3 locates between the top shell 1 and the bottom shell. A driving unit on the PCB 3 is connected to the LCD 4 in order to control the LCD 4. The Battery 6 which provides power supply to the driving unit connects to PCB 3. According to the features of the present patent application, a reflecting module 5 locates under the LCD 4. A reflector corresponding with the above-mentioned LCD 4 locates on the reflecting module 5. The above-mentioned reflector includes the illuminable polyhedrons made by materials such as diamond, crystal, glass, plastic, metal and their analogs. When the LCD needs to be illuminated and the displaying segments turn to be transparent, these illuminable or reflecting polyhedrons will reflect lights in various colors, thus increase the watch and clock's viewing and admiring performance.

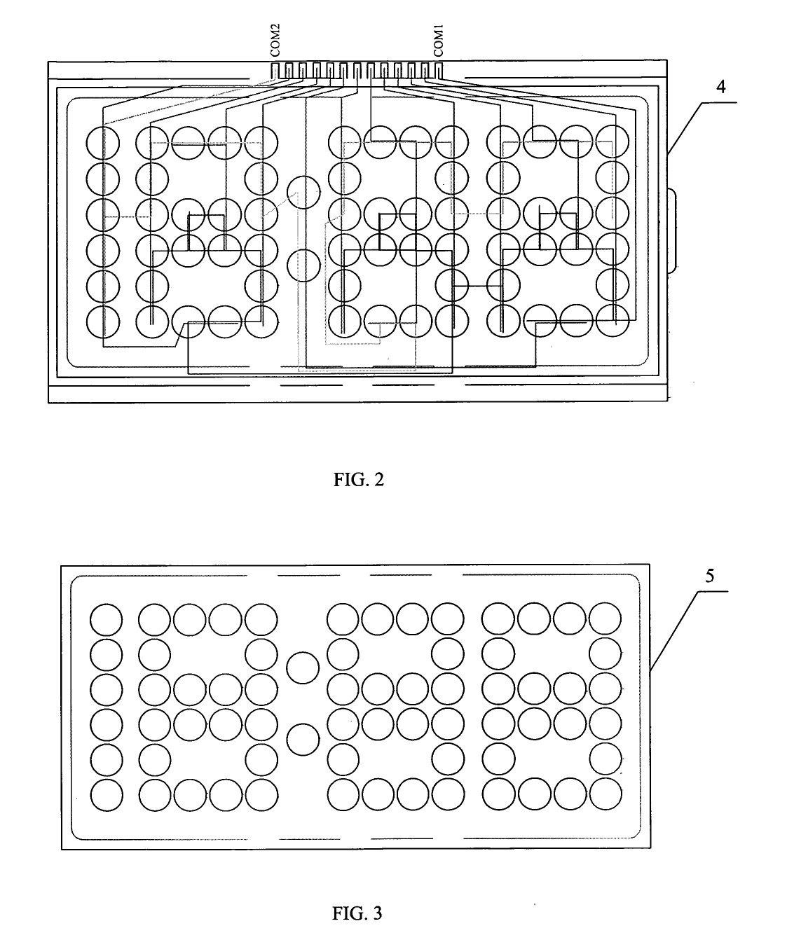

FIG. 2 shows the structural diagram of the LCD 4 of the multicolored LCD watch/clock according to the present patent application. As shown in the FIG. 2, multiple displaying segments form a “18.88” pattern. It should be noted that this is only an example of the present patent application, and these multiple displaying segments can form other patterns. Then, according to the present patent application, place illuminable polyhedrons under the displaying segments so that the illuminable polyhedrons will reflect the lights from the illuminated displaying segments when the driving unit controls the numeral digits corresponding with the displaying segments of the LCD thus to illuminate lights in various colors. “18:88” pattern can only display the 12-hour time system, if the display of 24-hour time system is required, then the “18:88” can be modified to “88:88” or other displaying patterns. Among them, each display segment is connected to the drive circuit via a communication interface by serial, parallel and independent means. Controlled by the drive circuit, the LCD 4 will display the corresponding time.

FIG. 3 shows the structural diagram of the reflecting module 5 of the multicolored LCD watch and clock in the present patent application. Corresponding with the displaying patterns shown in FIG. 2, the multiple illuminable polyhedrons attached on the reflecting module 5 also form the corresponding patterns. These reflecting polyhedrons might be made by materials such as diamond, crystal, glass, plastic, metal and their analogs. When the displaying segments of the LCD are illuminated, these illuminable polyhedrons will reflect lights from the transparent displaying segments. Then, depend on which illuminable polyhedron material is adopted, illuminate lights in different colors.

The above-mentioned is only a preferred embodiment of the present patent application, and it is not intended to limit it. Any modification, equivalent replacement and improvement within the concept and principle of the present patent application should be included in the protection scope of the present patent application.

1. A multicolored LCD watch/clock, comprising a top shell (1), a bottom shell (2), a drive circuit and a LCD (4) which is located on the said top shell (1) and is connected to the said drive circuit, characterized in that there is a reflecting module (5) under the said LCD (4), wherein multiple reflectors corresponding with the said LCD (4) are arranged on the said reflecting module (5).

2. The multicolored LCD watch/clock according to the claim 1, characterized in that the said reflector includes reflecting polyhedrons which are made of diamond, crystal, glass, plastic, metal and the like.

3. The multicolored LCD watch/clock according to the claim 1, characterized in that a PCB (3) is arranged between the said top shell (1) and the said bottom shell (2), wherein the said drive circuit locates on the said PCB (3).

4. The multicolored LCD watch/clock according to the claim 3, characterized in that a battery (6) connected to the said drive circuit is arranged on the said PCB (3).
